(19) United States
(12) Patent Application Publication
(10) Pub. No.: US 2024/0295915 A1
(43) Pub. Date: Sep. 5, 2024

(54) METHOD FOR SAVING POWER, WEARABLE DEVICE, AND COMPUTER READABLE STORAGE MEDIUM

(71) Applicant: HTC Corporation, Taoyuan City (TW)

(72) Inventors: Hao-Yun Chao, Taoyuan City (TW); Yao-Te Tsai, Taoyuan City (TW); Chen-Si Dai, Taoyuan City (TW)

(73) Assignee: HTC Corporation, Taoyuan City (TW)

(21) Appl. No.: 18/176,478

(22) Filed: Mar. 1, 2023

(51) Int. Cl. G06F 1/3231; G06F 1/16; G06F 3/01

(52) U.S. Cl. CPC G06F 1/3231; G06F 1/163; G06F 1/1694; G06F 3/013

(57) ABSTRACT

The embodiments of the disclosure provide method for saving power, a wearable device, and a computer readable storage medium. The method includes: obtaining a motion detection result provided by a motion detector; obtaining a touch detection result provided by a touch detector; determining whether the wearable device is in a static state at least based on the motion detection result and the touch detection result; and switching the wearable device to a power saving mode in response to determining that the wearable device is in the static state.

### BACKGROUND

### 1. Field of the Invention

The present disclosure generally relates to a power management mechanism, in particular, to a method for saving power, a wearable device, and a computer readable storage medium.

### 2. Description of Related Art

Wireless wearable devices usually run with a high battery consuming once turned on or paired. Even when a wearable device is idle, it keeps consuming battery the way as they are being used.

Since wearable devices are usually designed to have compact structure, sizes of built-in batteries are limited, such that the batteries may not be able to provide satisfying usage time length due to the above reasons.

### SUMMARY OF THE INVENTION

Accordingly, the disclosure is directed to a method for saving power, a wearable device, and a computer readable storage medium, which may be used to solve the above technical problems.

The embodiments of the disclosure provide a method for saving power, adapted to a wearable device including a motion detector and a touch detector. The method includes: obtaining a motion detection result provided by the motion detector; obtaining a touch detection result provided by the touch detector; determining whether the wearable device is in a static state at least based on the motion detection result and the touch detection result; and switching the wearable device to a power saving mode in response to determining that the wearable device is in the static state.

The embodiments of the disclosure provide a wearable device having a motion detector, a touch detector, and a processor. The processor is coupled to the motion detector and the touch detector and performs: obtaining a motion detection result provided by the motion detector; obtaining a touch detection result provided by the touch detector; determining whether the wearable device is in a static state at least based on the motion detection result and the touch detection result; and switching the wearable device to a power saving mode in response to determining that the wearable device is in the static state.

The embodiments of the disclosure provide a non-transitory computer readable storage medium, the computer readable storage medium recording an executable computer program. The executable computer program is loaded by a wearable device to perform steps of: obtaining a motion detection result provided by a motion detector of the wearable device; obtaining a touch detection result provided by a touch detector of the wearable device; determining whether the wearable device is in a static state at least based on the motion detection result and the touch detection result; and switching the wearable device to a power saving mode in response to determining that the wearable device is in the static state.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a wearable device according to an embodiment of the disclosure.

FIG. 2 shows a flow chart of the method for saving power according to an embodiment of the disclosure.

FIG. 3 shows a schematic diagram of the motion state of the wearable device according to the second embodiment of the disclosure.

FIG. 4 shows a schematic diagram of the power states of the wearable device according to an embodiment of the disclosure.

FIG. 5 shows a schematic diagram of the power state machine of the wearable device according to another embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

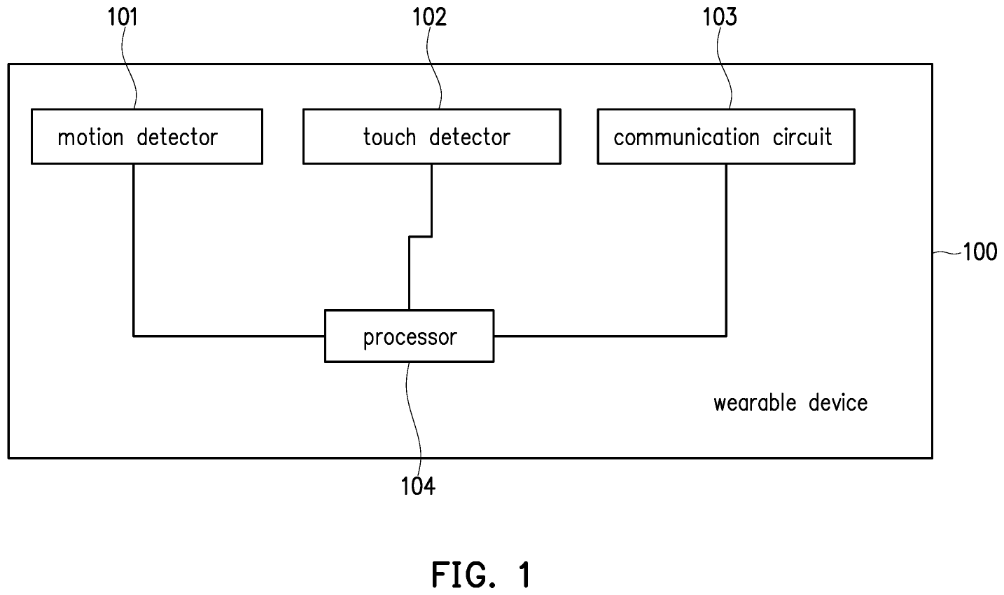

See FIG. 1, which shows a schematic diagram of a wearable device according to an embodiment of the disclosure. In various embodiments, the wearable device 100 can be implemented as a smart ring, a smart bracelet, a smart necklace, a smart watch, smart glasses, or the like.

In FIG. 1, the wearable device 100 includes a motion detector 101, a touch detector 102, a communication circuit 103, and a processor 104.

In the embodiments of the disclosure, the motion detector 101 can be any circuit capable of tracking the pose/motion of the wearable device 101, such as an inertia measurement unit (IMU), but the disclosure is not limited thereto.

In the embodiments of the disclosure, the touch detector 102 can be any circuit capable of detecting touch operations, such as a fingerprint sensor, a touch panel, or the like. In one embodiment, the touch detector 102 can be an optical finger navigation (OFN) circuit, and the user can perform touch operations such as tapping, sliding, dragging, tap and hold on the OFN circuit to interact with a host connected with the wearable device 100.

In different embodiments, the host can be any smart device (e.g., a smart phone and/or a tablet computer) or computer device. In one embodiment, the host can be a head-mounted display (HMD) used for providing a visual content of a reality service, wherein the reality service can be an augmented reality (AR) service, a virtual reality (VR) service, a mixed reality (MR) service, an extended reality (ER) service, or the like. In this case, the user can interact with the visual content (e.g., VR content) of the reality service via operating the OFN circuit, but the disclosure is not limited thereto.

In the embodiments of the disclosure, the host (e.g., the HMD) can be disposed with an eye tracking circuit and a proximity sensor, wherein the eye tracking circuit can track the gaze point of the user, and the proximity sensor can be used to detect whether the HMD is worn by the user.

In one embodiment, the visual content can be designed with one or more manipulation area. When the gaze point of the user of the HMD locates in the one or more manipulation area, it can be regarded that the user is interacting with the visual content, and the visual content can be referred to as satisfying an interacted condition. On the other hand, when no gaze point locates in the one or more manipulation area, it can be regarded that the user is not interacting with the visual content, and the visual content can be referred to as satisfying a non-interacted condition, but the disclosure is not limited thereto.

In various embodiments, the host can provide an eye tracking result to the wearable device 100, wherein the eye tracking result may be used to indicate whether the visual content satisfies the interacted condition or the non-interacted condition, but the disclosure is not limited thereto.

The communication circuit 103 can be any wireless protocol communication module for performing data exchange with, for example, the host, such as a Bluetooth Low Energy (BLE) module or the like.

The processor 104 is coupled with the motion detector 101, the touch detector 102, and the communication circuit 103, and the processor 104 may be, for example, a microcontroller unit (MCU), a general purpose processor, a special purpose processor, a conventional processor, a digital signal processor (DSP), a plurality of microprocessors, one or more microprocessors in association with a DSP core, a controller, Application Specific Integrated Circuits (ASICs), Field Programmable Gate Array (FPGAs) circuits, any other type of integrated circuit (IC), a state machine, and the like.

In the embodiments of the disclosure, the processor 104 may access particular modules and/or program codes to implement the method for saving power provided in the disclosure, which would be further discussed in the following.

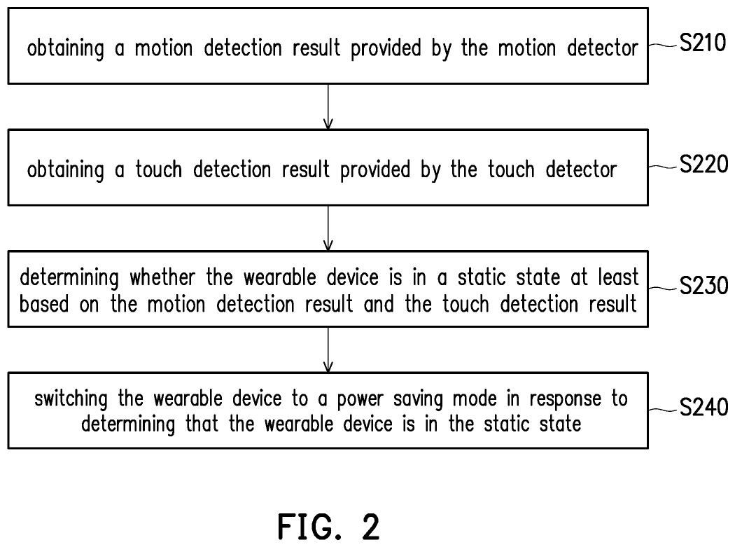

See FIG. 2, which shows a flow chart of the method for saving power according to an embodiment of the disclosure. The method of this embodiment may be executed by the wearable device 100 in FIG. 1, and the details of each step in FIG. 2 will be described below with the components shown in FIG. 1.

In step S210, the processor 104 obtains a motion detection result provided by the motion detector 101. In the embodiments of the disclosure, the motion detection result may be some measurement value characterizing the motion of the wearable device 100, such as 6 degree-of-freedom (6DOF) values detected by the IMU, but the disclosure is not limited thereto.

In one embodiment, the processor 104 can determine whether the motion detection result indicates that the wearable device 100 is barely moving. For example, if the processor 104 determines that the variations of the 6DOF values of the wearable device 100 in a first duration is less than a certain amount, the processor 104 may determine that the wearable device 100 is barely moving in the first duration. In this case, the processor 104 may determine that the motion detection result corresponding to the first duration satisfies a non-moving condition.

On the other hand, if the processor 104 determines that the variations of the 6DOF values of the wearable device 100 in a second duration is not less than a certain amount, the processor 104 may determine that the wearable device 100 is moving in the second duration. In this case, the processor 104 may determine that the motion detection result corresponding to the second duration does not satisfy the non-moving condition, but the disclosure is not limited thereto.

In step S220, the processor 104 obtains a touch detection result provided by the touch detector 102. In the embodiments of the disclosure, the touch detection result may be some measurement value characterizing the touch operation inputted to the touch detector 102.

In one embodiment, the processor 104 can determine whether the touch detection result indicates that the touch detector 103 is barely touched. For example, if the processor 104 determines that the strengths of the measurement values detected by the touch detector 103 in a third duration is less than a strength threshold, the processor 104 may determine that the touch detector 103 is barely touched in the third duration. In this case, the processor 104 may determine that the touch detection result corresponding to the third duration satisfies a non-touched condition.

On the other hand, if the processor 104 determines that the strengths of the measurement values detected by the touch detector 103 in a fourth duration is not less than the strength threshold, the processor 104 may determine that the touch detector 103 is touched in the fourth duration. In this case, the processor 104 may determine that the touch detection result corresponding to the fourth duration satisfies a touched condition, but the disclosure is not limited thereto.

In step S230, the processor 104 determines whether the wearable device 100 is in a static state at least based on the motion detection result and the touch detection result.

In a first embodiment, in response to determining that the motion detection result satisfies the non-moving condition and the touch detection result satisfies the non-touched condition, the processor 104 may determine that the wearable device 100 is in the static state. On the other hand, in response to determining that the motion detection result does not satisfy the non-moving condition or the touch detection result does not satisfy the non-touched condition, the processor 104 may determine that the wearable device 100 is not in the static state. In one embodiment, the wearable device 100 not in the static state can be referred to as in an moving state, but the disclosure is not limited thereto.

In a second embodiment, the processor 104 may determine whether the wearable device is in the static state at least based on the motion detection result, the touch detection result, and the eye tracking result. For example, in response to determining that the motion detection result satisfies the non-moving condition, the touch detection result satisfies the non-touched condition, and the eye tracking result indicates that the visual content satisfies the non-interacted condition, the processor 104 may determine that the wearable device 100 is in the static state. On the other hand, in response to determining that the motion detection result does not satisfy the non-moving condition, the touch detection result does not satisfy the non-touched condition, or the eye tracking result indicates that the visual content does not satisfy the non-interacted condition, the processor 104 may determine that the wearable device 100 is not in the static state (e.g., in the moving state), but the disclosure is not limited thereto.

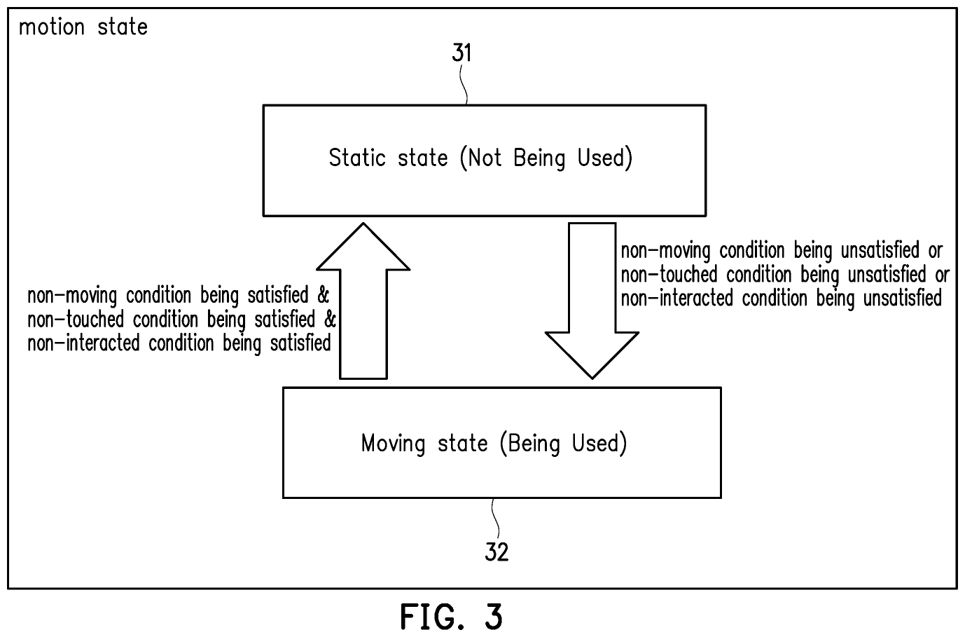

See FIG. 3, which shows a schematic diagram of the motion state of the wearable device according to the second embodiment of the disclosure. In FIG. 3, when the non-moving condition, the non-touched condition, and the non-interacted condition are satisfied, the motion state of the wearable device 100 can be regarded as in the static state 31, which can be understood as the wearable device 100 is not being used by the user. On the other hand, when the non-moving condition, the non-touched condition, and/or the non-interacted condition are unsatisfied, the motion state of the wearable device 100 can be regarded as in the moving state 32, which can be understood as the wearable device 100 is being used by the user, but the disclosure is not limited thereto.

In step S240, the processor 104 switching the wearable device 100 to a power saving mode (e.g., a sleep mode) in response to determining that the wearable device 100 is in the static state.

In one embodiment, the processor 104 may switch the wearable device 100 to the power saving mode in response to determining that the wearable device 100 has been in the static state for a predetermined time length, but the disclosure is not limited thereto.

Accordingly, the power consumption of the wearable device 100 can be reduced due to switching to the power saving mode from time to time, which lengthens the usage time of the wearable device 100.

In other embodiments, the processor 104 can switch the wearable device 100 to the power saving mode based on other additional principles.

In one embodiment, in response to determining that a wireless connection between the wearable device 100 and the host (e.g., the HMD) is disconnected or the host is in an off state, the processor 104 can switch the wearable device 100 to the power saving mode. Accordingly, the power consumption of the wearable device 100 can be further reduced.

In one embodiment, in the process of the processor 104 switching the wearable device 100 to the power saving mode, the processor 104 may switch itself and the touch detector 103 to a sleep mode and switch the motion detector 102 (e.g., IMU) to a wake on motion (WoM) mode.

In the embodiment where the touch detector 103 is implemented by using the OFN, the OFN can still detect touch operations after being switched to the sleep mode. In one embodiment, when the OFN in the sleep mode detects a (substantial) touch operation, the OFN may send an interrupt signal to the processor 104 to wake up the processor 104 from the sleep mode. Similarly, when the IMU in the WoM mode detects that the wearable device 100 is in (substantial) motion, the IMU can also wake up the processor 104 from the sleep mode, but the disclosure is not limited thereto.

After the processor 104 wakes up, the processor 104 may control the communication circuit 103 to send a connection establishment signal to the host for establishing a wireless connection with the host.

In one embodiment, after switching the wearable device 100 to the power saving mode, the processor 104 can further determine whether the wearable device 100 is in a worn state or an unworn state based on the at least based on the motion detection result and the touch detection result.

In one embodiment, in response to determining that the motion detection result satisfies the non-moving condition and the touch detection result satisfies the non-touched condition when the wearable device 100 is in the power saving mode, the processor 104 may determine that the wearable device 100 is in the unworn state (e.g., the wearable device 100 is taken off and put at some place). On the other hand, in response to determining that the motion detection result does not satisfy the non-moving condition or the touch detection result does not satisfy the non-touched condition when the wearable device 100 is in the power saving mode, the processor 104 may determine that the wearable device 100 is in the worn state (e.g., worn on the finger of the user), but the disclosure is not limited thereto.

In one embodiment, in response to determining that the wearable device 100 is in the worn state when the wearable device 100 is in the power saving mode, the processor 104 may maintain the communication circuit 103 of the wearable device in a broadcasting mode. In this case, after the processor 104 wakes up from the sleep mode, the processor 104 can directly control the communication circuit 103 to send the connection establishment signal to the host.

On the other hand, in response to determining that the wearable device 100 is in the unworn state when the wearable device 100 is in the power saving mode, the processor 104 may switch off the communication circuit 103. In this case, after the processor 104 wakes up from the sleep mode, the processor 104 may need to turn on the communication circuit 103 and then control the communication circuit 103 to send the connection establishment signal to the host, but the disclosure is not limited thereto. In one embodiment, the communication circuit 103 can be switched off before the processor 104 switches itself to the sleep mode, but the disclosure is not limited thereto. Since the communication circuit 103 can be switched off in the above scenario, the power consumption of the wearable device 100 can be further reduced.

In one embodiment, in response to determining that a resume command has been received from the host when the wearable device 100 is in the power saving mode, the wearable device 100 can be accordingly switched from the power saving mode to an active mode by waking up the processor 104, the touch detector 101 and the motion detector 103, but the disclosure is not limited thereto. In one embodiment, the host may send the resume command in response to determining that the host has been worn, but the disclosure is not limited thereto.

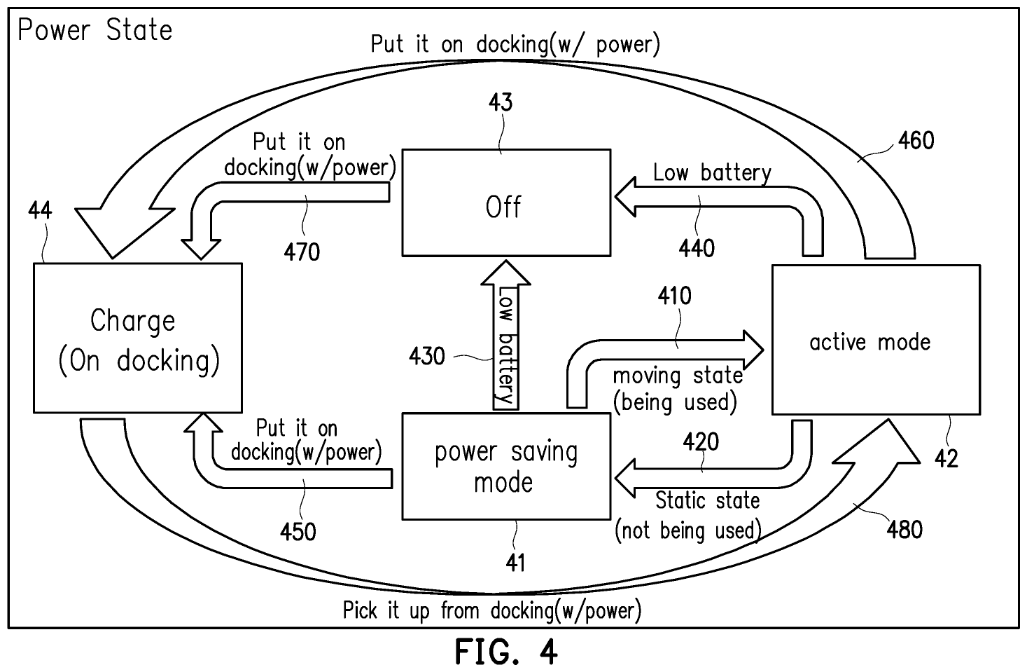

See FIG. 4, which shows a schematic diagram of the power states of the wearable device according to an embodiment of the disclosure. In FIG. 4, the wearable device 100 can be switched between the active mode 42 and the power saving mode 41 based on the motion state of the wearable device 100. If the wearable device 100 is determined to be in the moving state when the wearable device 100 is in the power saving mode 41, the wearable device 100 can be accordingly switched to the active mode 42 in flow 410. If the wearable device 100 is determined to be in the static state when the wearable device 100 is in the active mode 42, the wearable device 100 can be accordingly switched to the power saving mode 41 in flow 420.

If the battery of the wearable device 100 is determined to be low when the wearable device 100 is in the power saving mode 41 or the active mode 42, the wearable device 100 can be accordingly switched to be the off state 43 in flow 430 or 440. If the battery of the wearable device 100 is put on the charging dock when the wearable device 100 is in the power saving mode 41, the active mode 42, or the off state 43, the wearable device 100 can be switched to the charging mode 44 in flows 450, 460, or 470.

If the wearable device 100 is picked up from the charging dock, the wearable device 100 can be switched to the active mode 42 in flow 480.

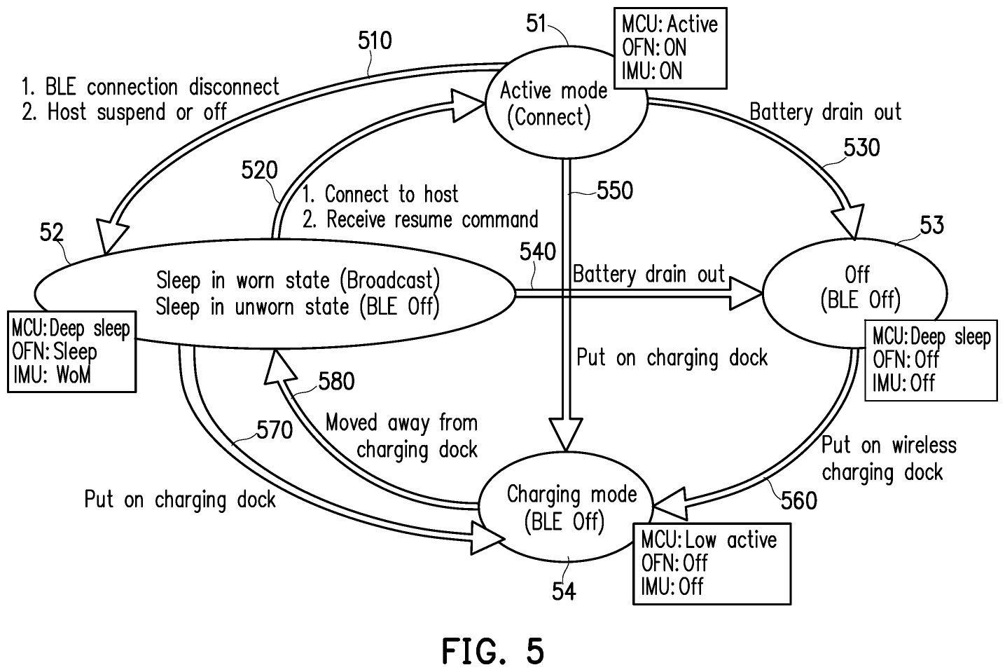

See FIG. 5, which shows a schematic diagram of the power state machine of the wearable device according to another embodiment of the disclosure. In the scenario of FIG. 5, it is assumed that the processor 104 is an MCU, the communication circuit 103 is a BLE module, the touch detector 102 is an OFN, and the motion detector 101 is an IMU, but the disclosure is not limited thereto.

In FIG. 5, when the wearable device 100 is in the active mode 51, the MCU can be in active, the OFN and the IMU can be on, and the BLE module can be in a connected state (e.g., having a wireless connection with the host).

In one embodiment, if the wireless connection (e.g., a BLE connection) between the wearable device 100 and the host is disconnected when the wearable device 100 is in the active mode or the host is determined to be suspended or off when the wearable device 100 is in the active mode, the wearable device 100 can be switched to the sleep mode 52 (i.e., the power saving mode) in flow 510.

When the wearable device 100 is in the sleep mode 52, the MCU can be in a deep sleep mode, the OFN can be in the sleep mode, and the IMU can be in the WoM mode. In addition, the BLE module can be off or in the broadcasting mode based on whether the wearable device 100 is in the worn state. If the wearable device 100 is in the worn state during the sleep mode 52, the BLE module can be maintained in the broadcasting mode; if the wearable device 100 is in the unworn state during the sleep mode, the BLE module can be turned off for saving more power.

In one embodiment, if the wearable device 100 is connected to the host or receives the resume command from the host in the sleep mode 52, the wearable device 100 can be switched to the active mode 51 in flow 520.

In one embodiment, if the battery of the wearable device 100 drains out during the active mode 51 or the sleep mode 52, the wearable device 100 can be switched to the off mode 53 in flows 530 or 540, wherein the MCU can be in the deep sleep mode, the OFN, the BLE module, and the IMU can be off.

In one embodiment, if the wearable device 100 is put on the charging dock during the active mode 51, the sleep mode 52, or the off mode 53, the wearable device 100 can be switched to the charging mode 54 in flows 550, 560, or 570, wherein the MCU can be in low active mode, the OFN, the BLE module, and the IMU can be off.

In one embodiment, if the wearable device 100 is moved away from the charging dock, the wearable device 100 can be switched to the sleep mode 52 in flow 580.

The disclosure further provides a computer readable storage medium for executing the method for saving power. The computer readable storage medium is composed of a plurality of program instructions (for example, a setting program instruction and a deployment program instruction) embodied therein. These program instructions can be loaded into the wearable device 100 and executed by the same to execute the method for saving power and the functions of the wearable device 100 described above.

In summary, the embodiments of the disclosure provide a mechanism that can switch the wearable device to the power saving mode at least based on the motion detection result provided by the motion detector (e.g., IMU) and the touch detection result provided by the touch detector (e.g., OFN). Since the wearable device can be switched to the power saving mode from time to time, the power consumption of the wearable device can be reduced, which lengthens the usage time of the wearable device.

In some embodiments, the eye tracking result provided by the host connected to the wearable device can be taken into consideration for determining whether to switch the wearable device to the power saving mode. In this case, the interaction of the user with the host can be further considered to better determine whether to switch the wearable device to the power saving mode.

In addition, after the wearable device is switched to the power saving mode, the communication circuit can be determined to be turned off or maintained in the broadcasting mode depending on whether the wearable device is in the unworn state or the worn state, which can be used to further reduce the power consumption of the wearable device.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for saving power, adapted to a wearable device having a motion detector and a touch detector, comprising:
obtaining a motion detection result provided by the motion detector;
obtaining a touch detection result provided by the touch detector;
determining whether the wearable device is in a static state at least based on the motion detection result and the touch detection result; and
switching the wearable device to a power saving mode in response to determining that the wearable device is in the static state.

2. The method according to claim 1, comprising:
in response to determining that the motion detection result satisfies a non-moving condition and the touch detection result satisfies a non-touched condition, determining that the wearable device is in the static state; and
in response to determining that the motion detection result does not satisfy the non-moving condition or the touch detection result does not satisfy the non-touched condition, determining that the wearable device is not in the static state.

3. The method according to claim 1, further comprising:
receiving an eye tracking result from a host connected with the wearable device, wherein the host provides a visual content of a reality service, and the step of determining whether the wearable device is in the static state at least based on the motion detection result and the touch detection result comprises:
determining whether the wearable device is in the static state at least based on the motion detection result, the touch detection result, and the eye tracking result.

4. The method according to claim 3, comprising:
in response to determining that the motion detection result satisfies a non-moving condition, the touch detection result satisfies a non-touched condition, and the eye tracking result indicates that the visual content satisfies a non-interacted condition, determining that the wearable device is in the static state; and
in response to determining that the motion detection result does not satisfy the non-moving condition, the touch detection result does not satisfy the non-touched condition, or the eye tracking result indicates that the visual content does not satisfy the non-interacted condition, determining that the wearable device is not in the static state.

5. The method according to claim 4, wherein the visual content comprises a manipulation area, and the method comprises:
in response to determining that the eye tracking result indicates that no gaze point locates in the manipulation area, determining that the visual content satisfies the non-interacted condition;
in response to determining that the eye tracking result indicates that a gaze point locates in the manipulation area, determining that the visual content does not satisfy the non-interacted condition.

6. The method according to claim 1, further comprising:
in response to determining that a wireless connection between the wearable device and a host is disconnected or the host is in an off state, switching the wearable device to the power saving mode.

7. The method according to claim 1, wherein the step of switching the wearable device to the power saving mode in response to determining that the wearable device is in the static state comprises:
switching a processor of the wearable device and the touch detector to a sleep mode; and
switching the motion detector to a wake on motion mode.

8. The method according to claim 7, wherein after the step of switching the wearable device to the power saving mode in response to determining that the wearable device is in the static state, the method further comprises:
determining whether the wearable device is in a worn state or an unworn state at least based on the motion detection result and the touch detection result;
in response to determining that the wearable device is in the worn state, maintaining a communication circuit of the wearable device in a broadcasting mode;
in response to determining that the wearable device is in the unworn state, switching off the communication circuit.

9. The method according to claim 8, comprising:
in response to determining that the motion detection result satisfies a non-moving condition and the touch detection result satisfies a non-touched condition, determining that the wearable device is in the unworn state; and
in response to determining that the motion detection result does not satisfy the non-moving condition or the touch detection result does not satisfy the non-touched condition, determining that the wearable device is in the worn state.

10. The method according to claim 8, further comprising:
in response to determining that the touch detector in the sleep mode detects a touch operation or the motion detector in the wake on motion mode detects that the wearable device is in motion, waking up the processor, the touch detector and the motion detector;
controlling the communication circuit to send a connection establishment signal to a host of the wearable device.

11. The method according to claim 8, further comprising:
in response to determining that a resume command has been received from a host of the wearable device, waking up the processor, the touch detector and the motion detector.

12. A wearable device, comprising:
a motion detector;
a touch detector, and
a processor, wherein the processor is coupled to the motion detector and the touch detector and performs:
obtaining a motion detection result provided by the motion detector;
obtaining a touch detection result provided by the touch detector;
determining whether the wearable device is in a static state at least based on the motion detection result and the touch detection result; and
switching the wearable device to a power saving mode in response to determining that the wearable device is in the static state.

13. The wearable device according to claim 12, wherein the processor performs:
in response to determining that the motion detection result satisfies a non-moving condition and the touch detection result satisfies a non-touched condition, determining that the wearable device is in the static state; and
in response to determining that the motion detection result does not satisfy the non-moving condition or the touch detection result does not satisfy the non-touched condition, determining that the wearable device is not in the static state.

14. The wearable device according to claim 12, wherein the processor performs:
receiving an eye tracking result from a host connected with the wearable device, wherein the host provides a visual content of a reality service;
determining whether the wearable device is in the static state at least based on the motion detection result, the touch detection result, and the eye tracking result.

15. The wearable device according to claim 14, wherein the processor performs:
in response to determining that the motion detection result satisfies a non-moving condition, the touch detection result satisfies a non-touched condition, and the eye tracking result indicates that the visual content satisfies a non-interacted condition, determining that the wearable device is in the static state; and
in response to determining that the motion detection result does not satisfy the non-moving condition, the touch detection result does not satisfy the non-touched condition, or the eye tracking result indicates that the visual content does not satisfy the non-interacted condition, determining that the wearable device is not in the static state.

16. The wearable device according to claim 15, wherein the visual content comprises a manipulation area, and the processor performs:
in response to determining that the eye tracking result indicates that no gaze point locates in the manipulation area, determining that the visual content satisfies the non-interacted condition;
in response to determining that the eye tracking result indicates that a gaze point locates in the manipulation area, determining that the visual content does not satisfy the non-interacted condition.

17. The wearable device according to claim 12, further comprising:
in response to determining that a wireless connection between the wearable device and a host is disconnected or the host is in an off state, switching the wearable device to the power saving mode.

18. The wearable device according to claim 12, wherein the processor performs:
switching the processor of the wearable device and the touch detector to a sleep mode; and
switching the motion detector to a wake on motion mode.

19. The wearable device according to claim 18, wherein after switching the wearable device to the power saving mode in response to determining that the wearable device is in the static state, the processor further performs:
determining whether the wearable device is in a worn state or an unworn state at least based on the motion detection result and the touch detection result;
in response to determining that the wearable device is in the worn state, maintaining a communication circuit of the wearable device in a broadcasting mode;
in response to determining that the wearable device is in the unworn state, switching off the communication circuit.

20. A non-transitory computer readable storage medium, the computer readable storage medium recording an executable computer program, the executable computer program being loaded by a wearable device to perform steps of:
obtaining a motion detection result provided by a motion detector of the wearable device;
obtaining a touch detection result provided by a touch detector of the wearable device;
determining whether the wearable device is in a static state at least based on the motion detection result and the touch detection result; and
switching the wearable device to a power saving mode in response to determining that the wearable device is in the static state.
